(19) United States
(12) Patent Application Publication
(10) Pub. No.: US 2006/0069986 A1
(43) Pub. Date: Mar. 30, 2006

(54) Technical specification editor

(76) Inventor: William Sandoval, Streamwood, IL (US)

Correspondence Address: OSTROLENK FABER GERB & SOFFEN, 1180 AVENUE OF THE AMERICAS, NEW YORK, NY, 100368403, US

(21) Appl. No.: 10/955,556

(22) Filed: Sep. 30, 2004

(51) Int. Cl. G06F 9/00

(52) U.S. Cl. 715/517; 715/531; 715/760

(57) ABSTRACT

The production of formal technical specification documents using a web-based interface is disclosed. The interface is used to identify one or more products, for example, lighting control systems that will be used in a construction. After receiving a selection of one or more products, a database is referenced to automatically retrieve text for the technical specification document that corresponds with the product(s), and a fully formatted technical specification document is generated for a user. Any portion of the technical specification document may be altered by the user via the user interface. Any technical specification document that is generated in accordance with the present invention can be stored to be used in the future as a template for new technical specification documents.

### BACKGROUND OF THE INVENTION

1. Field of the Invention

The present invention relates generally to generating technical specifications, and, more particularly, to the creation and distribution of technical specification documents over a communication network.

2. Description of the Related Art

Parties contributing to the construction of a residential or commercial building typically bid for particular projects. In order to prepare accurate bids, the multitude of details related to building materials and labor must be identified in formal technical specification documents that are included in the bid proposals. To promote uniformity, standards for technical specification documents have been adopted, such as those defined by the Construction Specifications Institute (“CSI”), that are imposed on building contractors. Such technical documents must adhere to strict rules with respect to formatting and content. The types of rules regarding formatting include page size, font types and point sizes, pagination, paragraph numbering or the like. Any technical document that does not comply with the rules is likely to be rejected, thereby preventing the contractor or subcontractor from winning a bid. At times, parties preparing the technical specification documents may be more skilled in word processing than in the technology the documents regard. Unfortunately, therefore, sometimes properly formatted technical specification documents may contain wrong information. Alternatively, it is also possible that technically accurate specification documents, such as those prepared by an engineer, may have errors with respect to formatting requirements.

When a technical specification document is generated, typically, standard “boilerplate” language that complies with formatting requirements is electronically inserted into a bid package. Due to the customized nature of buildings, in general, bid proposal packages that rely on such boilerplate and pre-formatted language are often not sufficient to describe one or more details of the building requirements. Often, boilerplate language must be changed or other language must be added which increases the likelihood that many tedious and time-consuming editing changes are required for the document to comply with the above-described formal requirements.

Software application systems have been designed that purport to ease the burden of preparing long and tedious technical specification documents. Unfortunately, these systems suffer from one or more shortcomings that ultimately require extensive user intervention. Often, parties submitting technical specification documents rely on automatic formatting processes and do not adequately proofread and correct inaccuracies in content and formatting.

The following briefly describes patent and non-patent related prior art regarding technical specification documents.

U.S. Pat. No. 6,236,409 (the “'409 patent”), assigned to The CSI, provides for a Method and Apparatus for Computer Aided Building Specification Generation. Disclosed is a system and method for producing a design document that corresponds with a product. In operation, a user selects a choice for a new or an existing project, and is provided a table of contents corresponding to assemblies of the product, information about the project, and contractual information.

Referring to an example embodiment in the '409 patent, a building is parsed into various product elements, similar to the CSI industry standard format. A plurality of cells contain types of information or attributes that characterize a product element. Qualitative and quantitative parameters are assigned to various product elements, and the product elements are organized in a hierarchical manner in a relational database. FIG. 3 of the '409 patent illustrates a series of steps that are performed and include receiving a selection for at least one product element (302), receiving at least one performance value associated with the element (304), receiving a text segment associated with each element (306), selecting a plurality of retrieved text segments for incorporation into the final document (308) and, at step 310, the system constructs the document using the selected text segments.

After a user has completed producing a design document, by selecting various product elements and performance values, reference information for the document is stored in an overlay file (column 10, lines 53-60). The overlay file can be sent in electronic form between entities during the design process. Further, multiple overlay files can be displayed for a comparative review by various entities. The data sets can be viewed individually, or compared (column 12, lines 10-20).

The system disclosed in the '409 patent does not retrieve and assemble portions of a technical specification document automatically based on identification of a single product. Instead, users select a product element, defined as a discrete part of a product, and text corresponding to each product element, stored in an individual cell used by the database, is retrieved (see column 5, lines 14-27). Users are afforded an opportunity to edit portions of the technical specification document. Further, overlay files for retrieving textual information from the database are produced and transmitted between parties for collaborative purposes.

Building Systems Design, Inc. (BSD) offers a product, SpecLink®, that provides a system for preparing and managing specification documents for building construction. SpecLink includes a database that stores text that is associated with elements of a product. After opening an existing or new project, a plurality of sections is provided in a “tree panel” that represent various divisions supported by the project. For example, site construction, concrete, masonry, metals, wood and plastics, and the like are available for selection. Once a section (or division) is selected, a plurality of section titles is provided in a “tree panel.” The tree panel allows the user to navigate through the database to select a section to review or edit. Once a section is chosen, text corresponding with the section is displayed. The text can be edited by the user.

The SpecLink product includes numerous links to related text that, when selected, cause additional text to appear in the document. The links are formatted in such a way to be easily identifiable to a user. For example, a finished technical specification is produced when a user makes selections corresponding to elements of a product. The SpecLink product does not compile a technical specification after receiving a selection of a particular product. Instead, a user must identify a division, and then manually select those portions of text that correspond with a particular product. Thus, the SpecLink product does not provide for automatic assemblage of documents in accordance with a single product selection. Furthermore, if a user neglects to select a link to related text, the SpecLink product may produce a technical specification that omits a significant detail. Moreover, although the SpecLink product appears to prevent inconsistent portions of text from being integrated into a single document, redundancies in text are not omitted.

U.S. Pat. No. 6,625,619 (the “'619 patent”), assigned to Building Systems Design, Inc., provides for Electronic Taxonomy For Construction Product Information. The '619 patent includes systems and methods for identifying and organizing an assembly of project item information in such a way that item data sets can be readily defined and recorded, quickly searched and compared. Further, the item sets can be transmitted among software applications and translated into a form without the requirement for human intervention. In one embodiment, a virtual product library is provided for item information received from disparate manufacturers, brokers or other developers of information in a given assembly industry. The item information can be integrated into a common environment. The common environment facilitates selection, specification and procurement of items related to a specific assembly project. See for example, FIG. 1. The '619 patent describes a preferred embodiment that is implemented as a web based system.

The '619 patent does not teach or suggest building technical specification documents by identifying a specific project or product and having a plurality of elements of the product retrieved for the user in order to pull information from a database directed to those elements.

Thus, as described above, the prior art systems for generation and distribution of technical specification documents have shortcomings that can result in a bid getting rejected on grounds of inaccuracy and/or non-compliance with formatting rules.

### SUMMARY OF THE INVENTION

There is a need for a system and method that generates a complete, properly formatted technical specification document after a user specifies a name or other identifier representing the document. Further, there is a need to transmit formal, completed technical specification documents as opposed to mere overlay files that require a database to be stored locally in order to generate a technical specification document. In accordance with an embodiment of the present invention, a user logs on to an Internet web site, provides a name for a completed specification, or identifies one or more products, and, in response, a technical specification document is retrieved, or newly generated.

The invention is directed to producing formal, properly formatted technical specification documents using a web-based software application comprising a database and user interface. A fully formatted technical specification document is automatically prepared in response to receiving an identification of a single product.

In a preferred embodiment, the database stores written paragraphs that are available for production of a technical specification document. In operation, a user preferably selects a graphic control, such as a check box, that represents a particular product, and the system retrieves corresponding paragraphs from the database, and compiles the paragraphs into a technical specification document. The interface enables users to edit any portion of the document. After the user is finished editing one or more portions, the present invention reformats the technical specification document to comply with the formal requirements, described above.

Preferably, the invention recognizes when content is repeatedly used in a specification and, when appropriate, removes redundancies from the technical specification document. After redundant content is removed from a technical specification document, the present invention substantially automatically reformats the document, for example by renumbering it.

The interface provided by the present invention allows a user, via standard web browser software, to select a particular product, for example, a lighting controller system. Graphical screen controls are provided, such as drop-down lists and check boxes, that enable the user to select and/or deselect portions of a technical specification to be included in the final, printed document. For example, a user selects a choice to produce a new technical specification document, selects a choice for a particular division, for example, lighting controls or window treatments, and thereafter selects a choice for a particular product. After the product is selected, a technical specification document is compiled using the paragraphs stored in the database automatically, and the user is provided choices (preferably, in the form of graphical screen controls) to add, modify or remove any paragraph. Thus, the user is able to customize sections of the technical specification document conveniently and quickly. Modified text can be reused in the form of a template for future production of technical specification documents.

Also, in an embodiment of the present invention, user activity, such as keystrokes are tracked for analysis. Furthermore, information, including technical specification documents, may be transmitted between different parties. By tracking user activity, various analyses can be performed to increase efficiency. For example, administrators can determine how frequently a technical specification document is altered prior to completion, the number of different parties who directly contribute to production of a technical specification document, or the like. Also, particular usage patterns can be determined and used to refine embodiments of the present invention.

Also, the present invention is developed to provide a shared platform by which the parties who contribute to building processes communicate with each other. For example, a salesperson who is responsible for a construction project is notified of a technical specification document that was created by an architect via the subject invention. The salesperson can view the technical specification, for example, via the web-based interface, and determine costs associated with his/her particular contribution to the process.

Other features and advantages of the present invention will become apparent from the following description of the invention, which refers to the accompanying drawings.

### BRIEF DESCRIPTION OF THE DRAWINGS

For the purposes of illustrating the invention, there is shown in the drawings a form that is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in accordance with an embodiment of the present invention;

FIG. 2 illustrates functional elements associated with an information processor;

FIG. 3 is an example sign-in screen for a registered user to log in and use an embodiment of the present invention;

FIG. 4 illustrates a main menu display screen in accordance with an embodiment of the present invention;

FIG. 5 shows a new commercial building definition display screen for creating a new commercial specification via the present invention;

FIG. 6 illustrates an example specification division selection display screen provided in accordance with an embodiment of the present invention;

FIG. 7 illustrates a select product display screen that is provided after a user identifies a specific division;

FIG. 8A is an example web browser display screen that is provided when a user selects a choice to open an existing specification in accordance with an embodiment of the present invention;

FIG. 8B is a display screen presented after a user selects a hyperlink representing a particular technical specification document;

FIG. 8C shows an example open technical specification document display screen that is presented to a user after selecting a particular revision in accordance with an embodiment of the present invention;

FIG. 9 illustrates a preview technical specification document display screen provided in accordance with an example embodiment of the present invention;

FIGS. 9A-9C illustrates choices that are available for navigating and modifying a technical specification document in accordance with an embodiment of the present invention;

FIG. 10 illustrates a sample display preview screen that illustrates a deleted portion of a technical specification document in accordance with an embodiment of the present invention;

FIGS. 11A-11E illustrate embodiments of the present invention for modifying specific portions within a section of a technical specification document;

FIG. 12A is a block diagram that illustrates three data tables in an example database in accordance with the present invention;

FIG. 12B illustrates results of a query in an example database in accordance with the present invention;

FIG. 12C is a black box diagram illustrating an example technical specification document table used by the present invention to provide a technical specification document;

FIG. 13A illustrates an example export specification display screen that provides export controls to convert a technical specification document to a MICROSOFT WORD format and an ADOBE ACROBAT PDF format;

FIG. 13B shows an example e-mail message display screen 1304 that can be used to transmit a technical specification document to an e-mail recipient; and

FIG. 14 illustrates an example product submittal sheet display screen 1400 that lists product submittal sheets, organized by category, for various products.

### DETAILED DESCRIPTION OF EMBODIMENTS OF THE INVENTION

The present invention is directed to producing technical specification documents using a web-based interface. The interface is preferably used to identify one or more products, for example, lighting control systems, which will be used in the construction of a building. After receiving a selection of one or more products, a database is preferably used to automatically retrieve text for the technical specification document that corresponds with the product(s), and a fully formatted technical specification document is generated for a user. Any portion of the technical specification document may be altered by the user via the user interface. Moreover, any technical specification document that is generated in accordance with the present invention can be stored to be used in the future as a template for new technical specification documents.

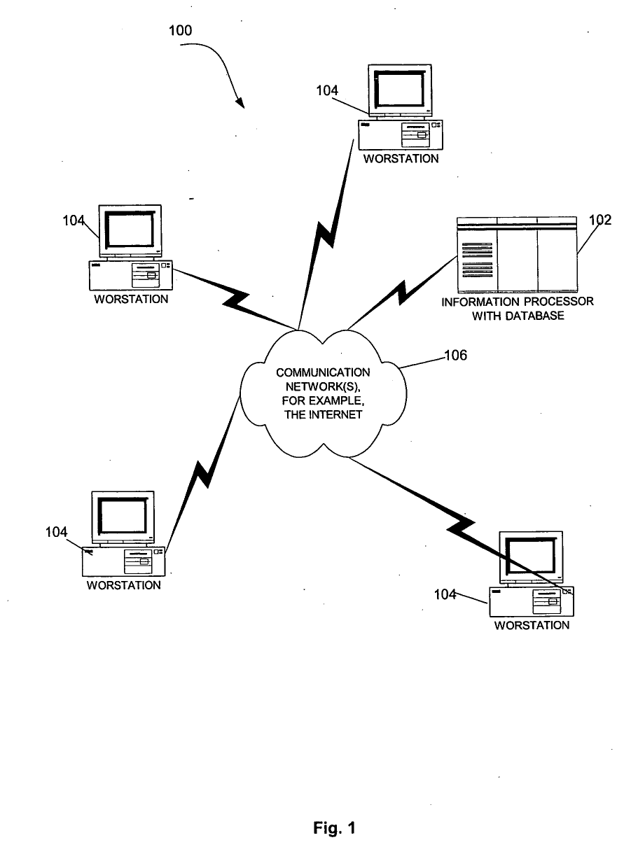

Referring to the drawing figures, in which like reference numerals refer to like references, FIG. 1 shows an example of a preferred embodiment of the present invention, including a hardware arrangement for providing formatted technical specification documents, and referred to generally as system 100. System 100 comprises at least one information processor 102 and at least one workstation 104, each of which is adapted to access communication network 106. The information processor 102 preferably provides an Internet web site that includes a database and user interface for users of workstations 104.

Information processor 102 preferably includes all databases necessary to support the present invention. However, it is contemplated that information processor 102 can access any required database via communication network 106 or any other communication network to which information processor 102 may be coupled. Communication network 106 is preferably a global public communication network such as the Internet, but can also be a wide area network (WAN), local area network (LAN), or other network that enables two or more computers to communicate with each other.

Preferably, information processor 102 and workstation 104 are any devices that are capable of sending and receiving data across communication network 106, e.g., mainframe computers, mini computers, personal computers, laptop computers, personal digital assistants (PDA) and Internet access devices such as Web TV. In addition, information processors 102 and workstations 104 are preferably equipped with a web browser, such as MICROSOFT INTERNET EXPLORER, NETSCAPE NAVIGATOR and the like. Information processors 102 and workstations 104 are coupled to communication network 106 using any known data communication networking technology.

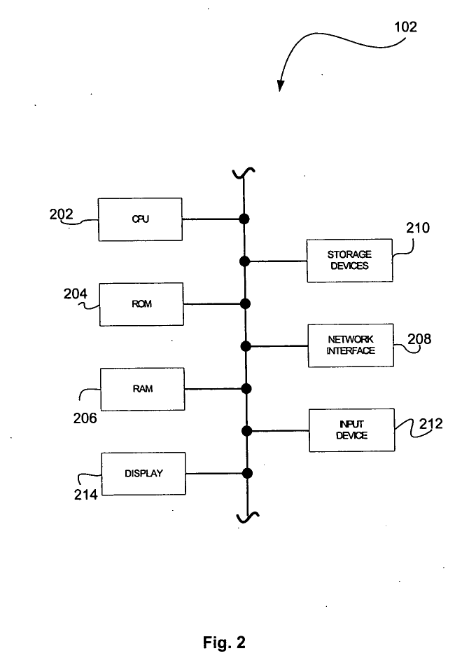

As shown in FIG. 2, the functional elements of information processor 102 are shown, and include one or more central processing units (CPU) 202 used to execute software code and control the operation of information processor 102, read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components of information processor 102 need not be physically contained within the same chassis or even located in a single location. For example, storage device 210 may be located at a site that is remote from the remaining elements of information processor 102, and may even be connected to CPU 202 across communication network 106 via network interface 208. Information processor 102 preferably includes a memory equipped with sufficient storage to provide the necessary databases, forums, and other community services as well as acting as a web server for communicating hypertext markup language (HTML), Java applets, Active-X control programs or the like to workstations 104. Information processors 102 are arranged with components, for example, those shown in FIG. 2, suitable for the expected operating environment of information processor 102. The CPU(s) 202, network interface(s) 208 and memory and storage devices 210 are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of information processor 102 shown in FIG. 2 are of the same categories of functional elements present in workstations 104. However, not all elements need be present in the workstations 104. For example, storage devices, in the case of PDAs, and the capacities of the various elements are arranged to accommodate the expected user demand. For example, CPU 202 in workstation 104 may be a smaller capacity CPU than the CPU present in information processor 102. Similarly, it is likely that information processor 102 will include storage devices of a much higher capacity than storage devices present in workstation 104. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and development environments including, but not limited to, C, C++, Visual Basic, JAVA, HTML, XML, ACTIVE SERVER PAGES, JAVA server pages, servlets, and a plurality of web site development applications.

Although the present invention is described by way of example herein and in terms of a web-based system using web browsers and a web site server (e.g., information processor 102), system 100 is not limited to such a configuration. It is contemplated that system 100 is arranged such that workstation 104 communicates with and displays data received from information processor 102 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102 and workstation 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 102 and workstation 104 regard the process of communicating data across communication network 106 and processing the data such that the data is viewed on a display 214, for example by using a web browser and the like. As is common with web browsing software, the display 214 on workstation 104 presents sites within the system 100 such that a user can proceed from site to site within the system by selecting a desired link.

Therefore, each user's experience with system 100 is based on the order with which he/she progresses through the display screens. Graphic controls are preferably available in the display screens and modules to initiate data processes, and to provide convenient navigation between the display screens and modules of system 100. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 100.

As used herein, the term, “technical specification documents” refers, generally, to documents that are required to comply with formatting rules and are used to define and describe materials and/or labor associated with various elements of a building construction. In a preferred embodiment of the present invention, technical specification documents are associated with bid proposals submitted for installation of lighting control systems in commercial and residential buildings.

A general description of the features of the present invention is provided below.

In an embodiment of the present invention, a web-based software application running on information processor 102 is provided to workstation 104 after a secure communication session has been established between workstation 104 and information processor 102. A user of workstation 104 makes selections provided in the software application in order to generate technical specification documents, for example, for commercial and residential buildings. In a preferred embodiment, the technical specification documents are directed to lighting control systems. The user of workstation 104 makes selections to create a new commercial or residential technical specification document, to open an existing technical specification document, or to perform various administrative tasks, such as generating reports, defining user profiles, or managing other user accounts (e.g., restricted to authorized personnel).

An existing technical specification document can be reviewed and modified by selecting a control, such as a hyperlink, in the software application provided by information processor 102. In an embodiment of the present invention, a user of workstation 104 reviews technical specification document names that were assigned previously. The names are preferably formatted as hyperlinks, and selection thereof causes information processor 102 to open the technical specification document for editing in accordance with the features described herein. For example, hyperlinks to specific portions of a technical specification document are provided for convenient navigation within the technical specification document. Text in the technical specification document may be edited (i.e., added, deleted and/or modified) in order to customize the document. A control is provided for the user to review the entire technical specification document on a display screen, or, alternatively to output the technical specification document to a printer.

Controls are also provided for a user to generate a new technical specification document, for example, directed to commercial or residential lighting controls. In an embodiment, a specification division (as defined by the CSI) is selected to represent the particular category of lighting control to which the technical specification document relates. After a division is selected, a specific product, for example, a particular lighting control system, is selected. The present invention preferably generates a complete “as is” technical specification document, which can be modified or saved for future use.

Thus, the present invention automatically generates a complete technical specification document after a selection representing a particular product, for example, a lighting control system, is received from a user.

A discussion regarding operation of the present invention is now provided with reference to the corresponding drawing figures.

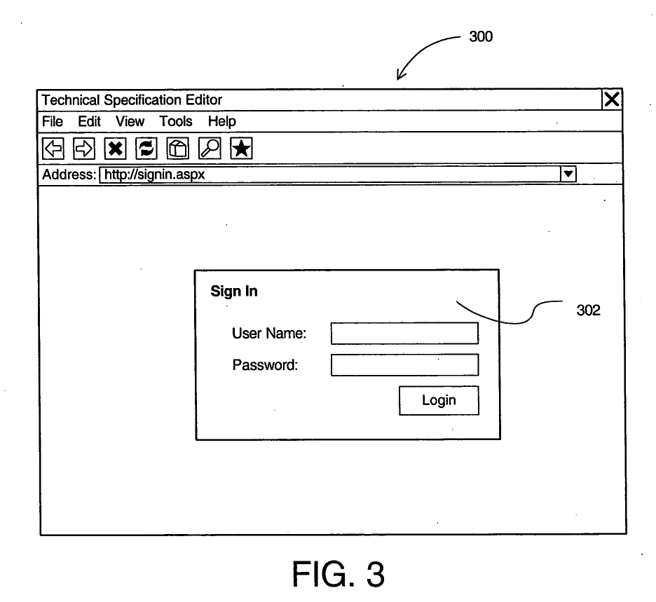

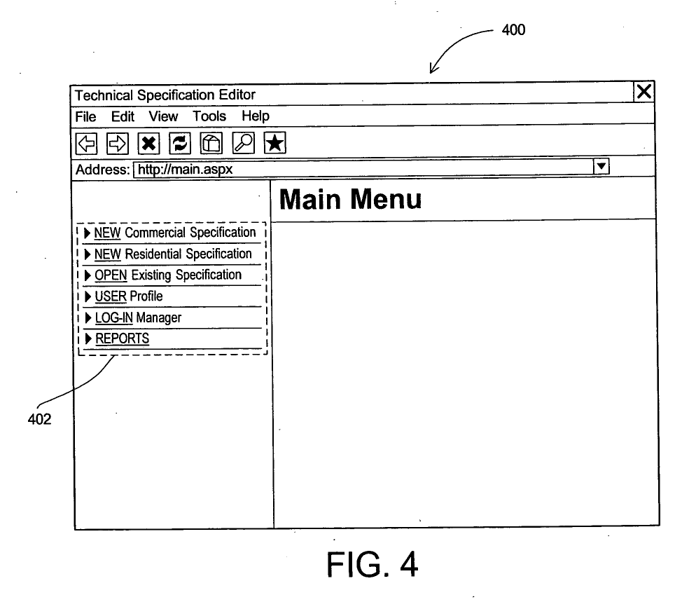

FIG. 3 illustrates an example sign-in screen 300 for a registered user to log in to information processor 102 in order to access and operate the present invention. The registered user submits a user name and password to be authenticated and presented with main menu display screen 400, as shown in FIG. 4.

Main menu display screen 400 preferably appears each time a user logs in to information processor 102 to operate the present invention. Main menu display screen 400 provides basic functionality associated with the present invention. For example, using section 402, shown on the left hand portion of main menu display screen 400, controls in the form of hyperlinks are provided for a registered user to create a new commercial specification, create a new residential specification, edit an existing specification and edit a user profile. Other options include a Log-In Manager hyperlink for administrative users, and a reports hyperlink to generate reports.

In a preferred embodiment of the present invention, menu choices associated with main menu 400 are provided in subsequent display screens. For example, the left most column of many of the display screens provided in accordance with the present invention include choices from main menu display screen 400.

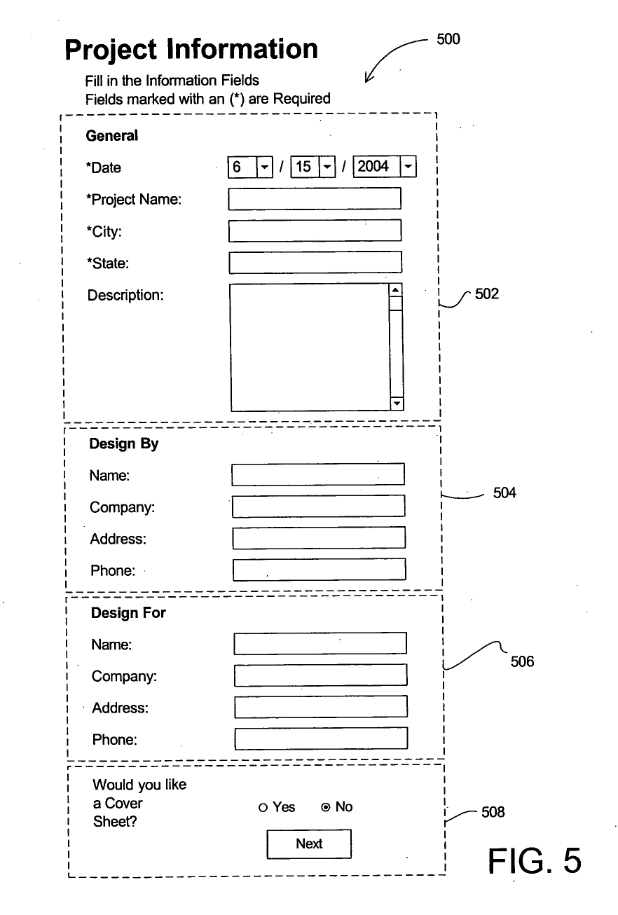

FIG. 5 illustrates a new commercial definition display screen 500 that is preferably provided to a registered user who selects a hyperlink corresponding with a choice for creating a new commercial specification in section 402. Project information display screen 500 contains a series of controls for a registered user to submit information regarding a technical specification document (identified as a “project” in FIG. 5). Generally, information section 502, includes graphic screen controls for receiving a date, a project name, a city, a state and a description of the technical specification document from a user. When a technical specification document is prepared, a cover sheet is optionally available that includes any information entered in general section 502. Display screen section 504 includes text entry controls that are used to identify the person creating the technical specification document. Display screen section 506 contains text entry controls to identify the party for whom the technical specification document is prepared. Additionally, a cover sheet option section 508 is available for a user to define whether a cover sheet is to be included in the technical specification document. Thus, using the controls provided in display screen 500, an audit trail can be established that identifies the technical specification document, the party creating the document and the party for whom the document is created.

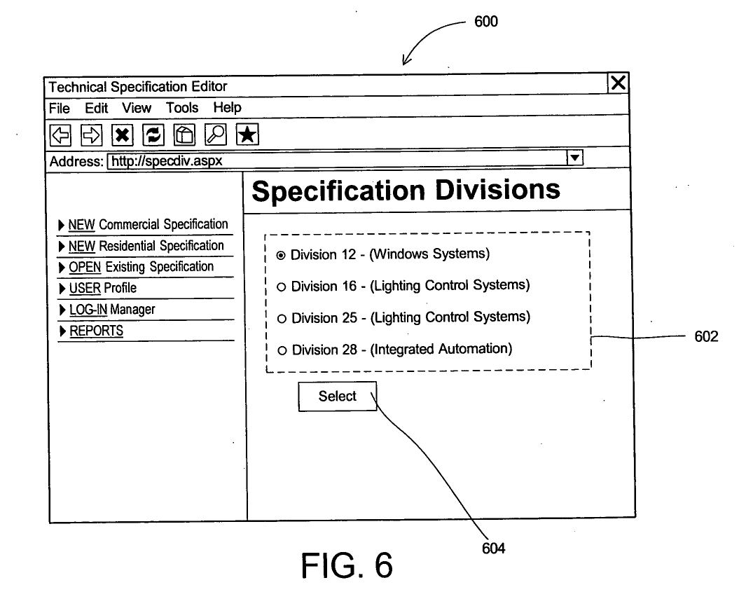

After a user submits information in display screen 500, information processor 102 preferably provides specification divisions selection display screen 600, as shown in FIG. 6. As noted above, in an embodiment of the present invention, technical specification documents that comply with standards defined by the CSI are automatically generated by the present invention. Language regarding one or more textual provisions is stored in a database, for example, on information processor 102 in storage device 210.

As noted above, in a preferred embodiment of the present invention, technical specifications are provided that regard lighting control systems. Accordingly, the example display screen shown in FIG. 6 illustrates controls that are provided to a registered user for divisions of specific lighting controls and that are defined by the Construction Specifications Institute. More particularly, a control is provided for Division 12 (window systems), Division 16 (lighting control systems), Division 25 (lighting control systems) and Division 28 (integrated automation). These options provide for furnishings, electrical and integrated automation details with respect to CSI formats, including MasterFormat™ 95 and MasterFormat™ 2004. In the example display screen 600 shown in FIG. 6, a user selects one of the particular divisions by selecting a control formatted as a radio button and then by selecting the select button 604. After the selection for a specific division is received by information processor 102, a selection of products that correspond with the selection of the division is preferably provided.

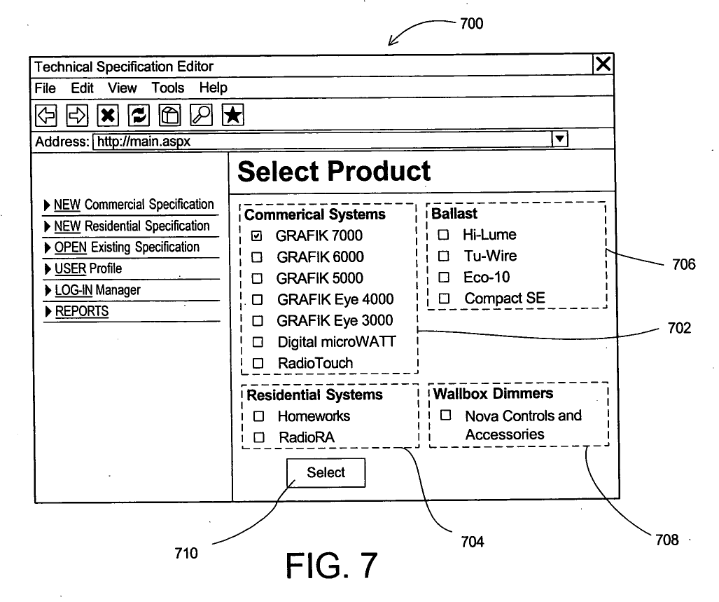

FIG. 7 illustrates a select product display screen 700 that is provided after a user submits a particular division. In the example shown in FIG. 7, commercial systems, residential systems, ballasts, and wall box dimmers are provided for a user's selection. In commercial systems section 702, choices for the GRAFIK 7000™, GRAFIK 6000®, GRAFIK 5000™, GRAFIK Eye® 4000, GRAFIK Eye® 3000, Digital microWATT™ and RadioTouch™ lighting control systems are provided. In residential section 704, choices for Homeworks® and RadioRA® lighting control systems are provided. In ballast section 706, choices for Hi-lume®, Tu-Wire®, Eco-10™, and Compact SE™ electronic ballasts are provided to the user. These are all commercial systems available from the assignee of the present application, Lutron Electronics Co., Inc. (hereinafter, “Lutron”).

Continuing with the example display screen 700, in Wallbox Dimmers section 708, a choice for Nova® Controls and Accessories (available from Lutron) is also provided for the user. In the example embodiment shown in FIG. 7, the user is provided with graphic screen controls that are formatted as check boxes and adjacent to each respective choice for the lighting control systems. As known by those skilled in the art, unlike choices provided by radio button controls, a user can select more than one checkbox to identify more than one choice the user desires. For example, a user may require technical specification documentation for the GRAFIK 5000 lighting control system and the Hi-lume ballasts. As described in greater detail below, any corresponding text that is to be included in the technical specification document and that is identified in more than one lighting control system, for example, the GRAFIK 5000 lighting control system and Hi-lume ballasts, preferably will be eliminated by the present invention to prevent redundancies in the text. Therefore, the present invention provides a convenient and easy to use system and method for identifying more than one product, and the invention correctly eliminates textual redundancies automatically. After the user is satisfied with his selections in display screen 700, the user selects select button 710 to submit his choices to information processor 102.

Unlike prior art technical design document computer systems, the present invention automatically compiles a technical specification document that is fully formatted after receiving an identification of one or more products by a user. The user is afforded opportunities to add, modify or delete any text that is automatically generated after information processor 102 receives the user's selections via the graphic screen controls as shown in FIGS. 4, 5 and 6.

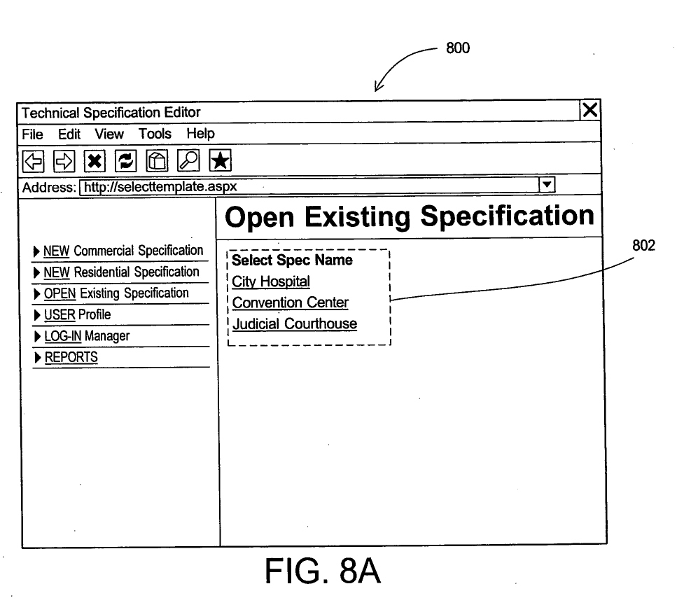

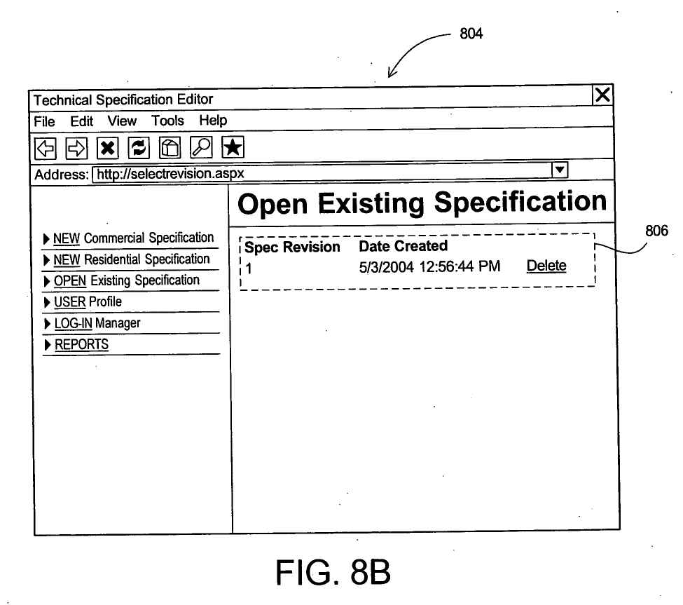

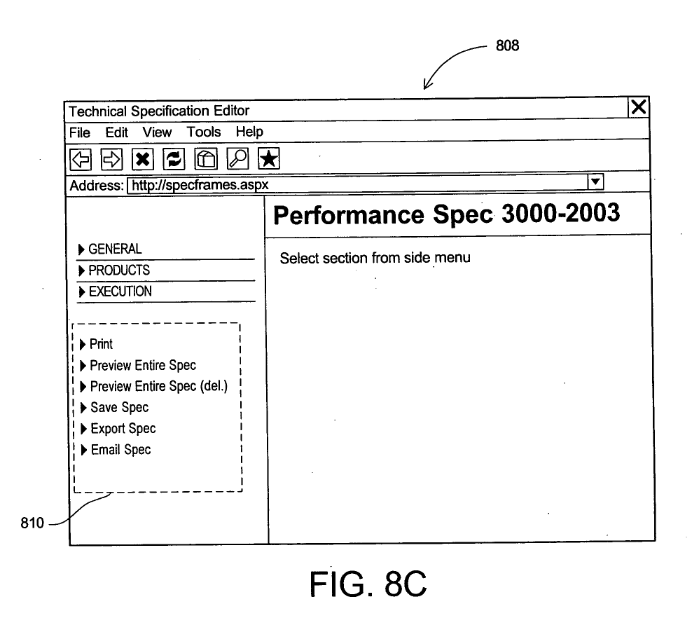

FIG. 8A is an example web browser display screen 800 that is provided when a user selects the open existing specification hyperlink from section 402 in main menu 400. Select specification name list 802 is provided in display screen 800 to enable a user to select a particular technical specification document. In a preferred embodiment of the present invention, select specification name list 802 comprises hyperlinks that, when selected, cause information processor 2 to retrieve the formatted technical specification document that corresponds with the selection. Preferably, the names of the technical specification documents that are provided in specification name list 802 are the same as those that were provided in general section 502 (FIG. 5) when the technical specification documents were initially generated.

After a user selects one of the hyperlinks representing a particular technical specification document, he is preferably presented with example display screen 804, as shown in FIG. 8B. Display screen 804 comprises open existing specification revision list 806 that enables a user to select a particular version of the technical specification document. In a preferred embodiment, users are afforded opportunities to save various versions of technical specification documents. This feature is particularly useful when, for example, more than one user works to develop a technical specification document. Enabling users to save various versions of a technical specification document is particularly useful to prevent an unintentional or otherwise undesirable change to a technical specification document from becoming permanent. In operation, a user selects a particular revision number to represent the version that the user desires to open. In the example shown in FIG. 8B, only one revision has been made, revision number 1.

FIG. 8C is an example open technical specification document display screen 808 that is presented to a user after a particular revision is selected in display screen 804. As shown in FIG. 8C, open technical specification document selection list 810 (in the left hand portion of display screen 808) enables a user to print, preview, save, export or e-mail a technical specification document.

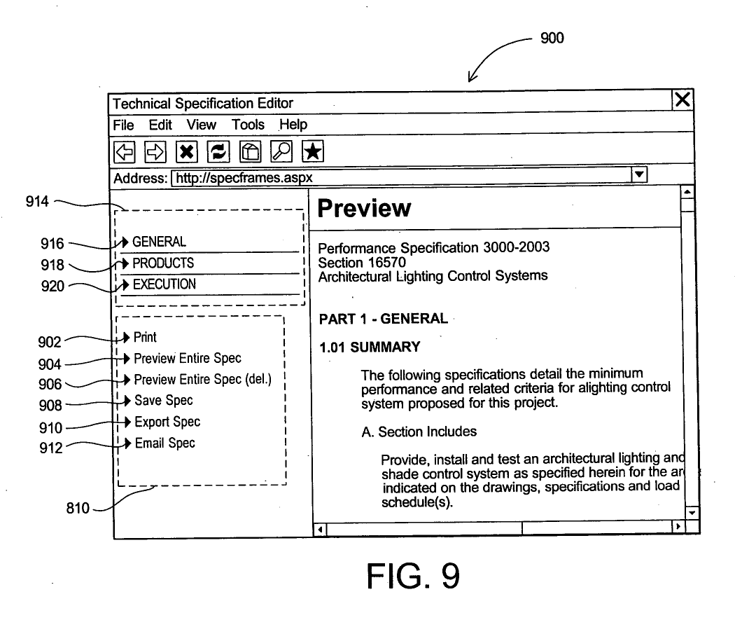

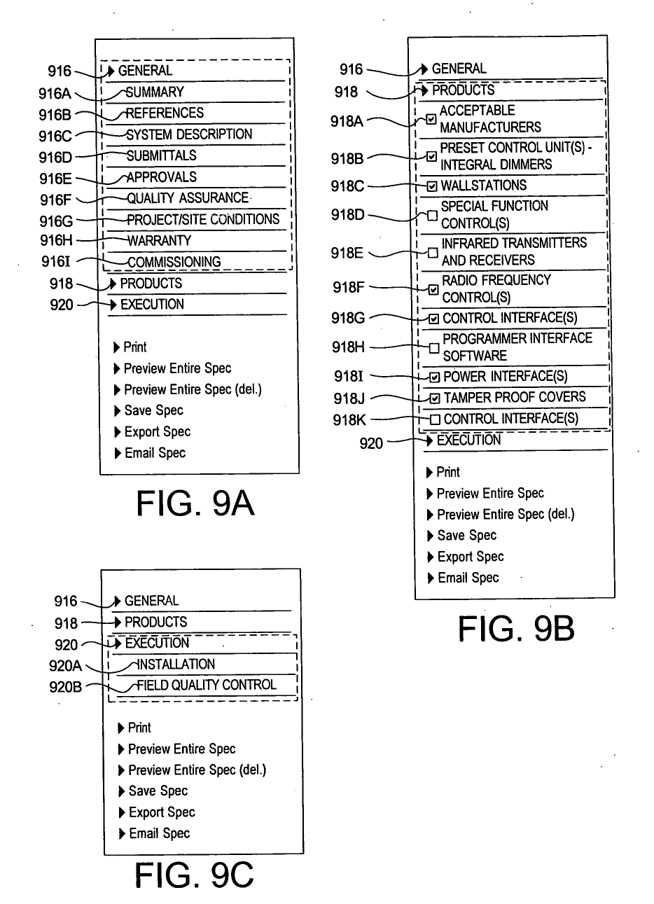

FIG. 9 illustrates a preview technical specification document display screen 900 that is presented when a user selects a hyperlink choice from list 810. After a user selects preview entire specification 904 from list 810, an entire formatted technical specification document is preferably presented for the user's review.

After a user of workstation 104 has selected one or more products, for example, using the controls provided in FIG. 7, a technical specification document representing the selected product(s) is automatically compiled from text stored in a database, and formatted according to particular design and format specifications. FIG. 9 shows an example web browser display screen 900 that includes a technical specification document that has been selected by a user, as described above with reference to FIGS. 8A, 8B and 8C.

In a typical scenario, changes to a technical specification document will be required in order to accurately describe the product and/or labor associated with a particular building requirement. Accordingly, the present invention provides controls and mechanisms that allow a user to modify, add or delete any portion of a technical specification document. After text is modified, the present invention automatically reformats (e.g., repaginates, renumbers and adjusts various layout characteristics) to ensure the technical specification document complies with various formal requirements.

While previewing a technical specification document, as shown in FIG. 9, controls are selected to enable a user to make editing changes to a technical specification document. Editing control section 914 includes options for general, products, and execution which represent various sections or chapters of a technical specification document and are preferably formatted as hyperlinks, and are selectable to retrieve respective sections in a technical specification document for editing. For example, FIG. 9A shows choices that are available after a user selects the General hyperlink 916.

As shown in FIG. 9A, hyperlinks are available for the respective sections within the general part of the technical specification document, including Summary hyperlink 916A, References hyperlink 916B, System Description hyperlink 916C, Submittals hyperlink 916D, Approvals hyperlink 916E, Quality Assurance hyperlink 916F, Project/Site Conditions hyperlink 916G, Warranty hyperlink 916H and Commission hyperlink 916I. By selecting one of these hyperlinks, the portion of the technical specification document corresponding with the selected hyperlink is automatically presented to the user.

FIG. 9B illustrates hyperlink choices that are available to navigate to respective portions of technical specification document after a user selects Products hyperlink 918. As shown in FIG. 9B, hyperlinks are available to enable a user to navigate to respective sections for Acceptable Manufacturers 918A, Preset Control Units—Integral Dimmers 918B, Wallstations 918C, Special Function Control(s) 918D, Infrared Transmitters and Receivers 918E, Radio Frequency Control(s) 918F, Control Interface(s) 918G, Programmer Interface Software 918H, Power Interface(s) 918I, Tamper Proof Covers 918J, and Source Quality Control 918K.

FIG. 9C illustrates hyperlink choices that are included in the technical specification document regarding Execution hyperlink 920, and include Installation 920A and Field Quality Control 920B.

Due to the customized nature of technical specification documents, some of the sections listed above, typically, are to be deleted from a technical specification document. For example, a builder may have no need to install infrared transmitters and receivers, even though in accordance with an example of the present invention the infrared transmitters and receivers section of the technical specification document is automatically inserted by the present invention. As noted above, the present invention preferably enables a user to modify, add or delete text in a technical specification document. In the example shown in FIG. 9B, infrared transmitters and receivers hyperlink 918C is not checked, indicating that the corresponding section of the technical specification document devoted to infrared transmitters and receivers will be omitted from the technical specification document.

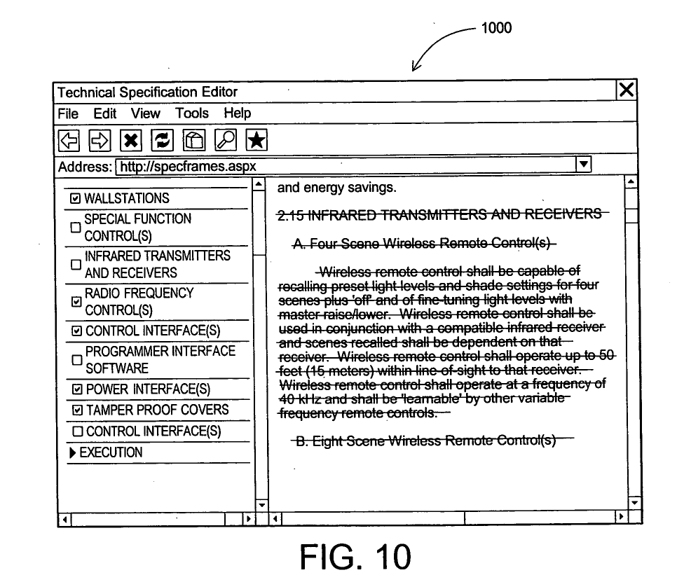

FIG. 10 illustrates a sample display preview screen 1000 that illustrates a deleted portion of a technical specification document, in this case, infrared transmitters and receivers. As shown in FIG. 10, the deleted portion is preferably formatted in a redlined font having a strikethrough characteristic, thereby alerting a user that the section has been deleted. Thus, simply by selecting and deselecting the checkbox controls illustrated in FIGS. 9A-9C, a user can add and remove whole sections of a technical specification document, and the sections will be properly formatted in a single keystroke or mouse click.

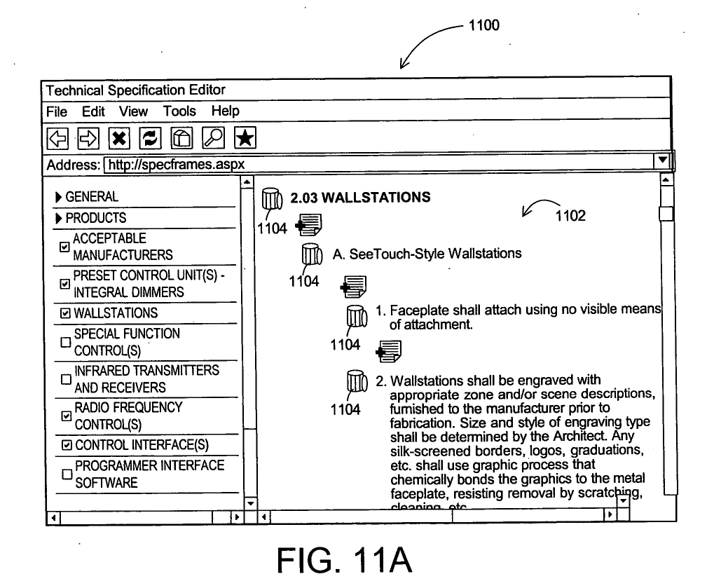

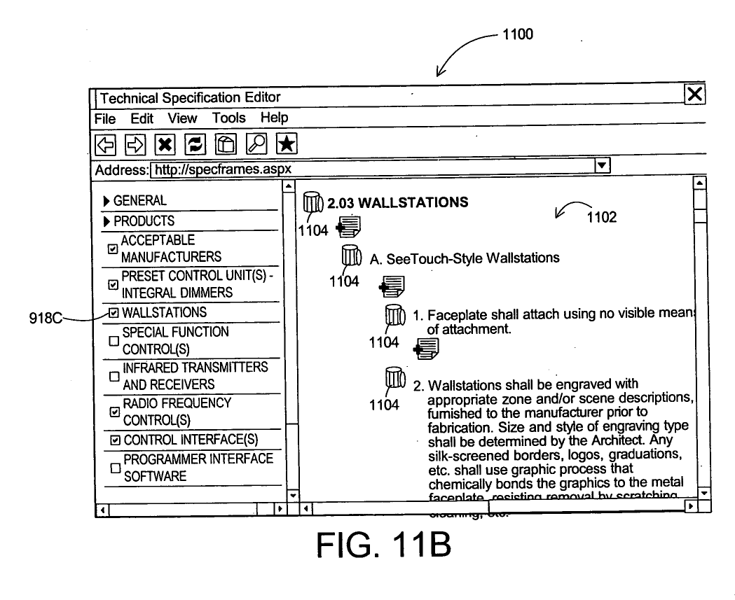

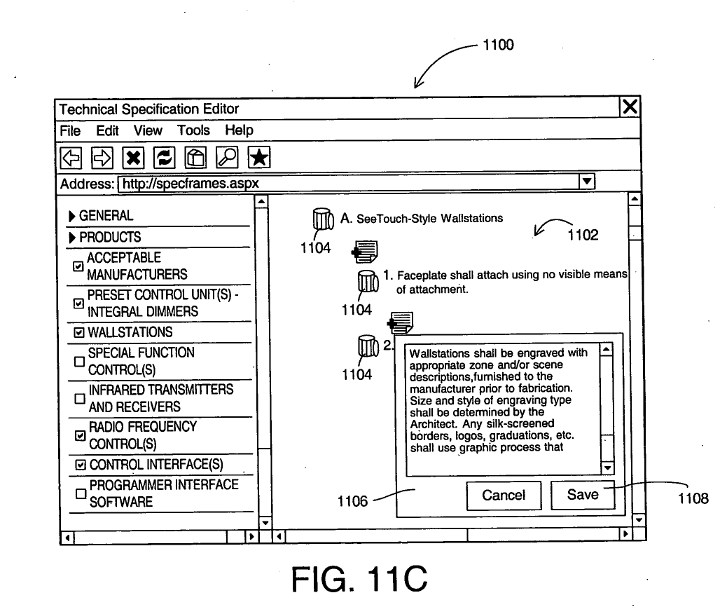

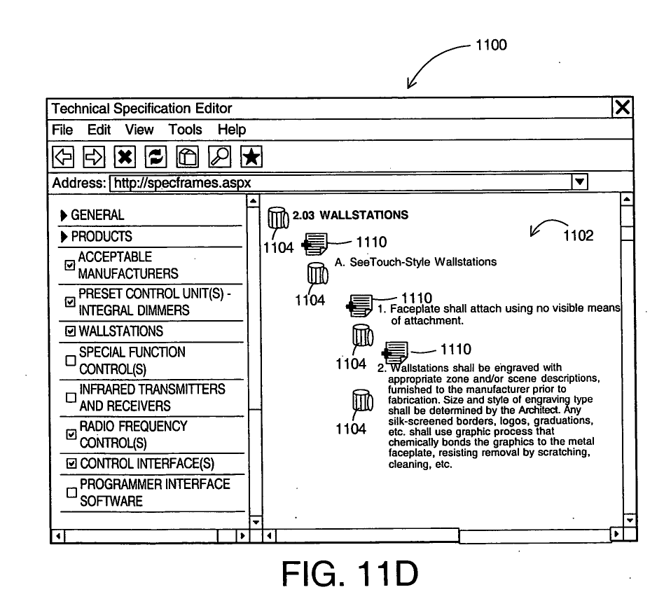

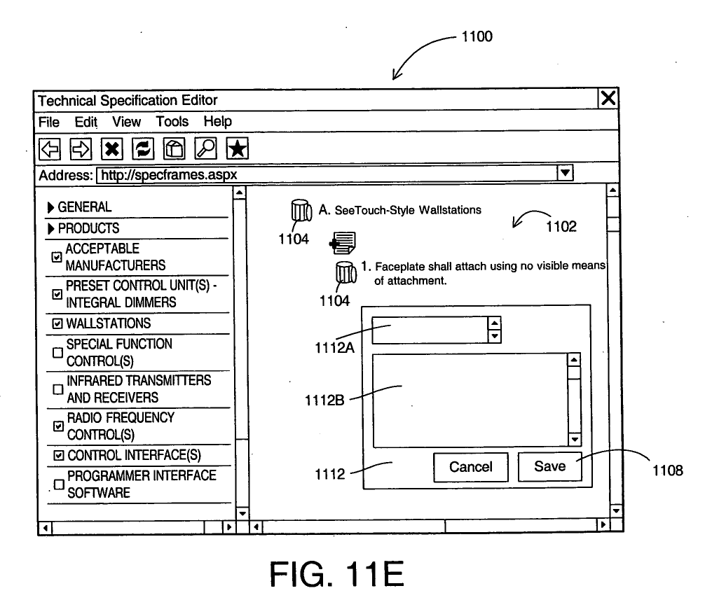

In the event that a user desires greater control and flexibility over the content in a technical specification document, the present invention provides additional controls and features that allow therefor. FIGS. 11A-11E illustrate embodiments of the present invention for modifying specific portions within a single section of a technical specification document.

FIG. 11A shows a web browser display screen 1100 provided in accordance with a preferred embodiment of the present invention. As shown in FIG. 11A, Wallstations hyperlink 918C has been selected, and the corresponding section in the technical specification document is displayed in the portion of display screen 1100, referred to herein, generally, as document portion 1102. Unlike the preview display screens described above and shown in FIGS. 9 and 10, for example, a series of graphic controls are preferably provided in document portion 1102 that, when selected, cause information processor 102 to make additions, deletions and modifications to the technical specification document. A brief description of ways to alter a technical specification document in accordance with an embodiment of the present invention is provided below.

In an embodiment of the present invention and illustrated in FIGS. 11A-11E, a technical specification document is altered by at least one of the following ways. As noted above, a section (or subsection) of a technical specification document can be removed by deselecting the checkbox next to sub-section title in the left navigation within sections 916, 918 and 920 (FIGS. 9A, 9B and 9C). In response, the subsection title changes to a different color, for example, red, thereby indicating its changed status. In an example embodiment, red colored hyperlinks represent deleted portions of a technical specification document, green colored hyperlinks represent modified portions, and black colored hyperlinks represent unaltered portions.

Within a section or subsection of a technical specification document, an entire paragraph can be deleted by selecting a respective subsection title hyperlink. In an embodiment, this is performed by selecting the hyperlink title associated with the section, and then selecting trashcan icon 1104 positioned next to the paragraph in document portion 1102. In response, information processor 102 causes the associated paragraph to change color, for example, to red, and to be formatted in a redlined font to indicate its status as deleted. FIG. 11A illustrates that the paragraph regarding wallstation engraving has been deleted in accordance with the method described above.

Paragraphs that are deleted in a technical specification document via the present invention can be reinstated by selecting the respective subsection hyperlink title in order to view content, and selecting trash can icon 1104 positioned next to the paragraph colored, for example, red. In response, information processor 102 causes the associated paragraph to change color from red, for example, to black, to indicate its status as non-deleted. FIG. 11B illustrates the paragraph regarding wallstations engraving has been reinstated.

In addition to removing and reinstating paragraphs within a section or subsection, a paragraph may be changed by a user via the present invention. A paragraph in the present invention can be modified by selecting the respective subsection hyperlink title to view content, and then using a mouse or other pointing device to select within the body of the paragraph. In response, information processor 102 causes editing window 1106 to appear in document portion 1104. As shown in FIG. 11C, a user navigates within editing window 1106 to make changes to the paragraph therein. After the desired changes are made, the user saves the changes, for example, by selecting Save button 1108. In response, information processor 102 causes the edited paragraph to change color, for example, to green, to indicate that changes to the original language of the paragraph have been made.

The present invention also provides a convenient interface for adding new paragraphs to a technical specification document. A paragraph in the present invention can be added by selecting the respective subsection hyperlink title to view content, and, thereafter, selecting new paragraph icon 1110 (FIG. 11D) corresponding to the location where the user desires to add a paragraph. After paragraph icon 1110 is selected, the user is presented with empty add new paragraph window 1112 (FIG. 11E). Add new paragraph window 1112 is distinct from editing window 1106 (FIG. 11C) in that text entry field 1112A is provided for a user to submit a title of the new paragraph, and paragraph body portion 1112B is provided for a user to provide the new paragraph. The new paragraph is formally added to the technical specification document after the user selects Save button 1108. In accordance with an embodiment of the present invention, the newly added paragraph is formatted in a green color, thereby indicating to a user that it was not part of the original technical specification document that was automatically generated after one or more products were selected by the user, for example as shown in display screen 700 (FIG. 7).

Thus, in accordance with an embodiment of the present invention, changes to a technical specification document can be easily made using a convenient Internet-based user interface that is capable of operating across various software platforms (e.g., WINDOWS, MACINTOSH, UNIX, or the like). Since the application is operable using standard web browsing software, users do not require special software or databases to generate complete technical specification documents. Furthermore, parties that are typically involved in construction processes, such as architects, engineers, lighting designers and salespersons, can use workstation 104 to establish a communication session with information processor 102 and generate, modify or output a technical specification document.

In an embodiment of the present invention, a relational database is used to store paragraphs associated with respective technical specification documents. Preferably, a data table is defined such that each single paragraph of a technical specification document is stored as a single record. Each record is further defined to include a corresponding value, such as a tag, that represents a respective product to which the paragraph applies. To generate a technical specification document for a GRAFIK 7000 lighting control system, for example, paragraphs are retrieved from the database that have the corresponding tag representing the GRAFIK 7000 lighting control system. The retrieved paragraphs are preferably added to a data table that represents a new technical specification document.

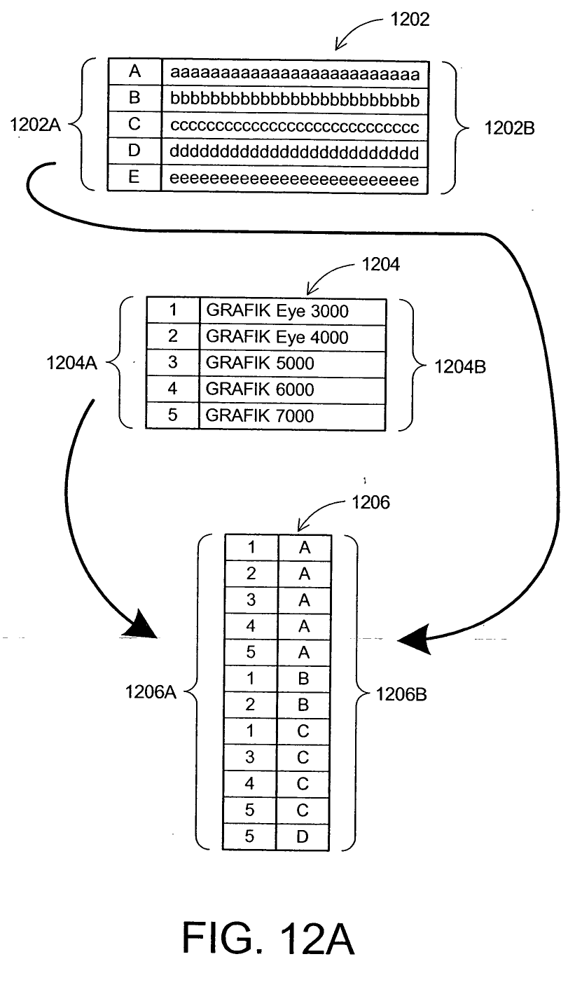

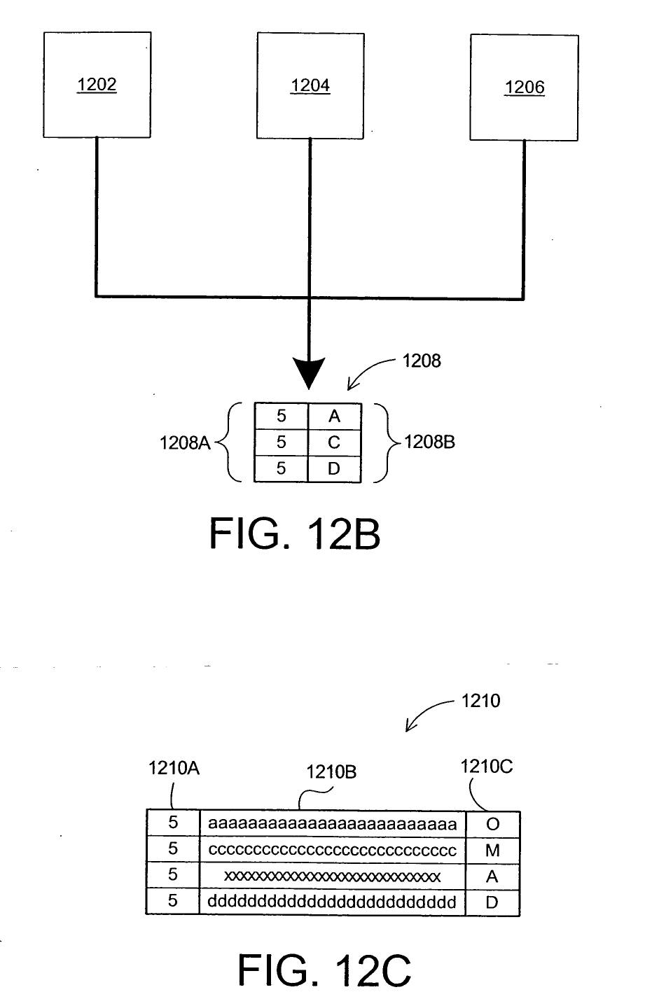

A discussion of an embodiment of the present invention representing database design is provided below with reference to FIGS. 12A-12C. The examples shown in FIGS. 12A-12C are provided to represent a simple layout and design of a database provided by the present invention. Of course, one skilled in the art will recognize that the number of columns, rows, tables and relationships may contain significantly more detail in a functional embodiment of the present invention.

FIG. 12A is a block diagram that illustrates three data tables in database 1200 that can be used by the present invention to retrieve paragraphs of text to generate a technical specification document for a particular product. Table 1202 represents a table of paragraphs, and includes two columns, 1202A and 1202B. Column 1202A includes incremental values that correspond with specific row numbers. Column 1202B includes text for individual paragraphs represented by letters A-E. Table 1204 represents a table of products, and includes two columns, 1204A and 1204B.

Continuing with the block diagram shown in FIG. 12A, column 1204A includes incremental values that correspond with specific row numbers. Column 1204B includes values that represent particular products, for example lighting control systems. Table 1206 represents an identification of the particular paragraphs to be included in technical specification documents for particular products, and includes two columns 1206A and 1206B. Column 1206A includes values from column 1204A (table 1204) to represent particular products, and column 1206B includes values from column 1202A (table 1202) to represent paragraphs associated with the products.

As shown in FIG. 12A, the first row of table 1206 includes (in column 1206A) the value 1 which represents the GRAFIK Eye 3000 lighting control system, and also includes (in column 1206B) the value A which represents the text associated with paragraph A. The second, third, fourth, and fifth rows in table 1206 identify products associated with values 2, 3, 4, and 5 and will also include paragraph A.

Continuing with the example shown in FIG. 12A, the GRAFIK Eye 4000 and GRAFIK 5000 lighting control systems (represented by the values 2 and 3, respectively, in table 1204) are associated with paragraph B (see the sixth and seventh row of table 1206). Furthermore, the GRAFIK Eye 3000, GRAFIK 5000, GRAFI 6000, and GRAFIK 7000 lighting control systems are associated with paragraph C (see rows 8-11 in table 1206). The GRAFIK 7000 lighting control system is further associated with paragraph D (see row 12 in table 1206).

As those skilled in the art will recognize, a database design such as the example shown in FIG. 12A is useful to represent large amounts of data in efficient ways. In this way, index values representing the text included in column 1202B (table 1202) are stored in table 1206 as opposed to the actual text itself. Such database design is useful to maximize performance while minimizing storage space requirements.

FIG. 12B illustrates results of a query in database 1200 for paragraphs that correspond with a GRAFIK 7000 lighting control system. Referring to FIG. 12A, the GRAFIK 7000 lighting control system is represented in table 1206 by the value 5. Query results table 1208 (FIG. 12B) includes two columns, 1208A and 1208B. Column 1208A includes the value 5 in each row (for the GRAFIK 7000 lighting control system), and the values A, C and D in column 1208B (rows 1-3) that represent paragraphs corresponding with the GRAFIK 7000 lighting control system.

Continuing with the present example regarding the GRAFIK 7000 lighting control system, FIG. 12C is a black box diagram illustrating example technical specification document table 1210 that is used by the present invention to provide a technical specification document in accordance with user interface features described above. Table 1210 preferably is generated from query results table 1208 and includes the value 5, representing the GRAFIK 7000 lighting control system, in column 1210A. Column 1210B includes the actual text that is included in the technical specification document, and which can be altered or deleted in accordance with the methods described above. Column 1210C includes a value for each record that represents the status of the text stored in column 1210B. For example, the value O represents the word “original” and indicates the text in column 1210B has not been altered from its original form from table 1202 (FIG. 12A). The value M represents the word “modified” and indicates the text in column 1210B has been altered from its original form from table 1202. The value A represents the word “added” and indicates the new text that a user has added to a technical specification document. The value D represents the word “deleted” and indicates that the corresponding text has been deleted from the technical specification document.

Thus, table 1210 can be used to generate a technical specification document that complies with formal formatting rules with respect to layout, pagination, paragraph numbering and the like. Using the values in columns 1210A, 1210B and 1210C, text can be added, modified or deleted and used in the production of a finished, formal technical specification document. By referencing codes that represent various statuses of text in a technical specification document, the present invention is able to format the text in the technical specification document. For example, any text that is associated with the value D is formatted in the color red and in a redlined font. Further, text that is associated with the value D may not be displayed in a technical specification document.

In accordance with a preferred embodiment of the present invention, any technical specification document that is generated and/or modified via the present invention can be used as a template for future technical specification documents. For example, a user may desire particular language to be included in every technical specification related to lighting control systems. Accordingly, the first technical specification document generated by the present invention is modified by the user to include the desired language. Thereafter, the technical specification document can be used as a template for producing new related technical specification documents.

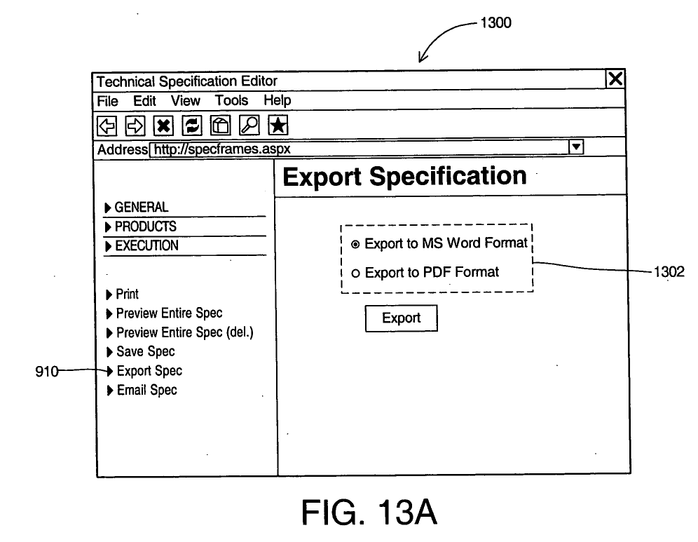

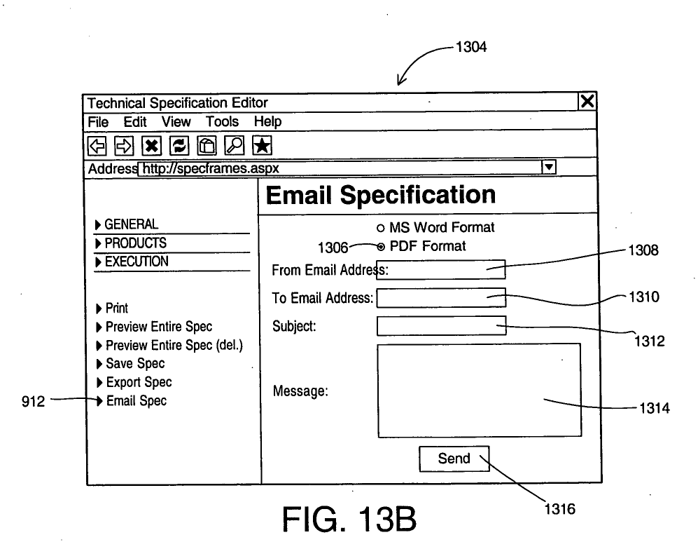

In addition to providing templates for future generation of technical specification documents, a user can export a technical specification generated via the present invention to be stored in various and commonly used formats. FIG. 13A illustrates an example export specification display screen 1300 that provides export controls 1302 to convert a technical specification document to a MICROSOFT WORD format and an ADOBE ACROBAT PDF format. Of course, one skilled in the art will recognize that many other document formats are available and can be applied by the present invention.

In addition to exporting technical specification documents to commonly used formats, the present invention provides a data entry display screen that enables a user to identify an e-mail recipient and to transmit a technical specification document to that recipient. FIG. 13B illustrates an example e-mail message display screen 1304 that can be used to transmit a technical specification document to an e-mail recipient. As shown in FIG. 13B, a user selects radio button 1306 to identify the format for the exported technical specification document. Next, the user identifies the sender's e-mail address and the recipient's e-mail address in text box controls 1308 and 1310, respectively. The user may also submit a subject line and message body using text box controls 1312 and 1314, respectively. When the user is satisfied with the entries, he selects Send button 1316, thereby causing information processor 102 to e-mail the user's message and exported technical specification document to the party identified in text box control 1308. Thus, a simple-to-use interface is provided by the present invention to e-mail technical specification documents from a user to a third party recipient. The features provided in display screen 1304 alleviate the need for a user to save a copy of a technical specification document locally at a workstation and then e-mail the document using the user's e-mail client software application. This saves valuable user time and frees computer-related resources.

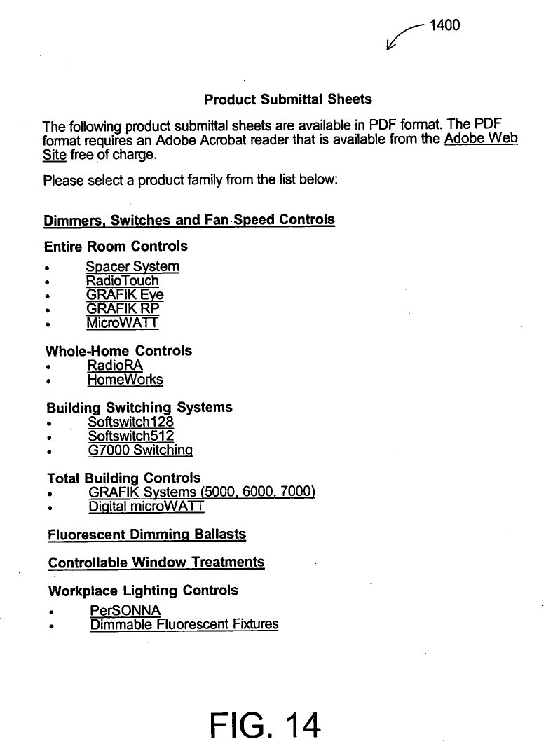

In accordance with an embodiment of the present invention, various technical papers related to various products are available for a user to review and/or download. In the example shown in the drawing figures starting with FIG. 4, a menu choice regarding product technical sheets is provided. When selected, a user's web browser is preferably redirected to a web site providing hyperlinks to product submittal sheets that can be included with a technical specification document in a bid. FIG. 14 illustrates an example product submittal sheet display screen 1400 that lists product submittal sheets, organized by category, for various products. The example product submittal sheet display screen 1400 is directed to lighting control systems.

Other features are preferably available via the present invention. For example, in an embodiment of the present invention, statistical reports can be generated that represent patterns in which the present invention is used. For example, the number of times a technical specification document is edited, accessed, e-mailed, or the like, can be represented in one or more reports.

Thus, the present invention provides a unique and convenient web-based system and method that generates a complete, properly formatted technical specification document after a user specifies a name or other identifier representing the document. After the user provides a name for a completed specification a technical specification document is retrieved for review or further editing. Alternatively, the user simply specifies a product name, and the present invention substantially automatically generates a fully formatted technical specification document.

Generating a complete, properly formatted technical specification document is advantageous compared with related prior art software applications. Unlike prior art systems, for example, that produce and distribute overlay files which typically require a database to be stored locally to provide a technical specification document, the present invention automatically provides a document. Thus, no a user can access and, if necessary, modify a technical specification document using well-known and widely distributed software, such as commercial word processing software. Also, since the present invent operates over the Internet and using a web-based interface, users are not restricted from using the present invention due to a particular operating system or other computing platform.

Although the present invention has been described in relation to particular embodiments thereof, many other variations and modifications and other uses will become apparent to those skilled in the art. Therefore, the present invention should be limited not by the specific disclosure herein.

What is claimed is:

1. A method for providing a technical specification document to at least one party, the method comprising:
electronically storing document formatting information in a database, the document formatting information representing rules for formatting the technical specification document;
storing electronic product information in the database, the electronic product information representing at least names of at least two products;
electronically storing textual provisions relating to technical specification documents in the database;
electronically storing textual provision matching information in the database, the textual provision matching information representing textual provisions stored in the database that correspond to the electronic product information;
electronically receiving a first product identification from the party, the first product identification representing at least the name of at least one of the at least two products;
retrieving from the database at least two textual provisions that correspond with the textual provision matching information and the first product identification;
electronically formatting the at least two textual provisions in accordance with the document formatting information to generate the technical specification document; and
electronically providing the technical specification document to the party.

2. The method of claim 1, wherein a textual provision is a paragraph.

3. The method of claim 1, further comprising storing the electronic specification document in a database.

4. The method of claim 1, further comprising:
electronically deleting a textual provision in the technical specification document when a respective graphic screen control associated with each textual provision is selected by a user; and
electronically reformatting the technical specification document in accordance with the document formatting information after the textual provision is deleted.

5. The method of claim 4, further comprising:
electronically reinstating the deleted textual provision when the respective graphic screen control is reselected; and
electronically reformatting the technical specification document in accordance with the document formatting information after the textual provision is reinstated.

6. The method of claim 4, further comprising providing a choice for at least one of displaying the technical specification document with the deleted textual provision in a redlined format and displaying the technical specification document without displaying the deleted textual provision.

7. The method of claim 1, further comprising:
electronically providing an editing window adapted to enable a user to modify a paragraph in the technical specification document when a respective graphic screen control associated with each textual provision is selected by a user; and
electronically reformatting the technical specification document in accordance with the document formatting information after the textual provision is modified.

8. The method of claim 1, further comprising:
electronically providing an editing window adapted to enable a user to add a new textual provision in the technical specification document when a respective graphic screen control associated with each textual provision is selected by a user; and
electronically reformatting the technical specification document in accordance with the document formatting information when the new textual provisions is added.

9. The method of claim 1, further comprising exporting the technical specification document to at least one of plain text, ASCII, binary, graphic, and compressed format.

10. The method of claim 9, further comprising e-mailing the exported technical specification document after a user provides a recipient e-mail address and at least one of a sender e-mail address, a subject line, and a message body.

11. The method of claim 1, further comprising:
electronically deleting a plurality of textual provisions in the technical specification document when a single respective graphic screen control associated with each the plurality of textual provisions is selected by a user; and
electronically reformatting the technical specification document in accordance with the document formatting information.

12. The method of claim 1, wherein the technical specification document complies with formatting defined by the Construction Specification Institute.

13. The method of claim 1, wherein the at least two products relate to lighting control systems.

14. The method of claim 1, further comprising electronically receiving a second product identification from the party, the second product identification representing at least the name of at least one other of the at least two products;
retrieving from the database at least two textual provisions that correspond with the textual provision matching information and the second product identification;
electronically formatting the at least two textual provisions in accordance with the document formatting information to generate the technical specification document; and
electronically providing the technical specification document to the party.

15. The method of claim 1, wherein the step of electronically formatting comprises removing redundancies in the at least two textual provisions.

16. A system for providing a technical specification document to at least one party, the system comprising:
a database formatting module adapted to store electronic document formatting information representing rules for formatting the technical specification document;
a database product information module adapted to store electronic product information representing at least names of at least two products;
a database textual provision module adapted to store textual provisions relating to technical specification documents;
a textual provision matching module adapted to match textual provisions stored in the database textual provision module with the electronic product information;
a product identification interface adapted to electronically receive a product identification representing at least the name of at least one of the at least two products from the at least one party;
a retrieval module adapted to retrieve from the database textual provision module at least two textual provisions that correspond with the textual provision matching information and the product identification;
a formatting module adapted to electronically format the at least two textual provisions in accordance with the document formatting information to generate the technical specification document; and
a presentation module adapted to electronically provide the technical specification document to the party.

17. The system of claim 16, further comprising a completed technical specification document module adapted to store the electronic specification document in a database.

18. The system of claim 16, further comprising a textual provision deletion module adapted to electronically delete a textual provision in the technical specification document when a respective graphic screen control associated with each textual provision is selected by a user.

19. The system of claim 18, further comprising a textual provision reinstatement module adapted to electronically reinstate the deleted textual provisions when the respective graphic screen control is reselected.

20. The system of claim 18, further comprising a redlined view module adapted to display the technical specification document with the deleted textual provision in a redlined format.

21. The system of claim 16, further comprising an editing window module adapted to enable a user to modify a textual provision in the technical specification document when a respective graphic screen control associated with each textual provision is selected by a user.

22. The system of claim 16, further comprising an editing window module adapted to enable a user to add a new textual provision in the technical specification document when a respective graphic screen control associated with each textual provision is selected by a user.

23. The system of claim 16, further comprising an export data module adapted to export the technical specification document to at least one of plain text, ASCII, binary, graphic, and a compressed format.

24. The system of claim 26, further comprising an e-mail module, adapted to e-mail the exported technical specification document after a user provides a recipient e-mail address and at least one of a sender e-mail address, a subject line, and a message body.

25. The system of claim 16, further comprising a section deletion module adapted to delete a section in the technical specification document when a respective graphic screen control associated with each section is selected by a user.

26. The system of claim 16, further comprising a tracking module adapted to track user activity associated with generating and editing technical specification documents.

27. The system of claim 26, wherein the tracking module tracks at least one of user keystrokes, user selection pointer actions, and display screens accessed by a user.

28. The system of claim 16, wherein the formatting module is further adapted to remove redundancies in the at least two textual provisions.
